(19) United States
(12) Patent Application Publication
(10) Pub. No.: US 2014/0085860 A1
(43) Pub. Date: Mar. 27, 2014

(54) LIGHT GUIDE MODULE FOR KEYPAD

(71) Applicants: FIH (Hong Kong) Limited, Kowloon (HK); SHENZHEN FUTAIHONG PRECISION INDUSTRY CO., LTD., Shenzhen (CN)

(72) Inventors: YE WANG, Shenzhen (CN); YONG-GANG ZHANG, Shenzhen (CN); KUAN-HUNG CHEN, Shindian (TW)

(21) Appl. No.: 13/914,833

(22) Filed: Jun. 11, 2013

(30) Foreign Application Priority Data
Sep. 24, 2012 (CN) 2012103573171

(51) Int. Cl. H04M 1/22

(52) U.S. Cl. CPC H04M 1/22
USPC 362/23.03

(57) ABSTRACT

A light guide module includes a touch plate, a light guide plate, an induction plate, a transparent double sided tape, a reflective double sided tape and a light source. The transparent double sided tape is adhered between the touch plate and the light guide plate. The reflective double sided tape is adhered between the light guide plate and the induction plate. The light source is located on the induction plate. The reflective double sided tape reflects light emitted by the light source to the light guide plate, the light guide plate directs the light to the touch plate through the transparent double sided tape.

### BACKGROUND

1. Technical Field

The present disclosure relates to light guide structures, and particularly to a light guide module for a keypad in a portable electronic device.

2. Description of Related Art

In portable electronic devices, keypads are illuminated using light sources, light guide plates and some optical elements. In a touch type keypad field, the light guide plates and the optical elements are spaced from each other and are sandwiched between a touch plate and an induction plate. As the distance between the light guide plates and the optical elements increases, the distance between the touch plate and the induction plate also increases. If the distance between the touch plate and the induction plate is too great, the touch plate might not be sensitive. Additionally, the distance between the optical elements and plates may make the keypad too thick for installation within the portable electronic device.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present light guide module. Moreover, in the drawings, like reference numerals designate corresponding parts throughout the several views.

FIG. 1 is an isometric view of an exemplary electronic device using a light guide module.

FIG. 2 is a schematic view of a first exemplary light guide module shown in FIG. 1.

FIG. 3 is an exploded view of the light guide module shown in FIG. 2.

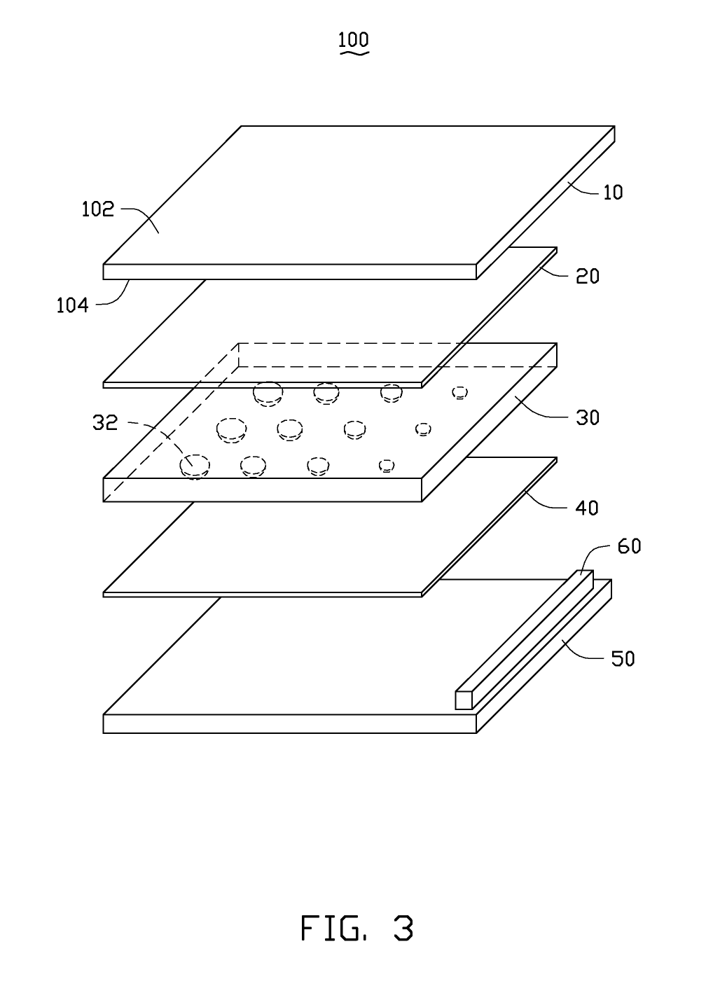

FIG. 4 is a schematic view of a second exemplary light guide module shown in FIG. 1.

### DETAILED DESCRIPTION

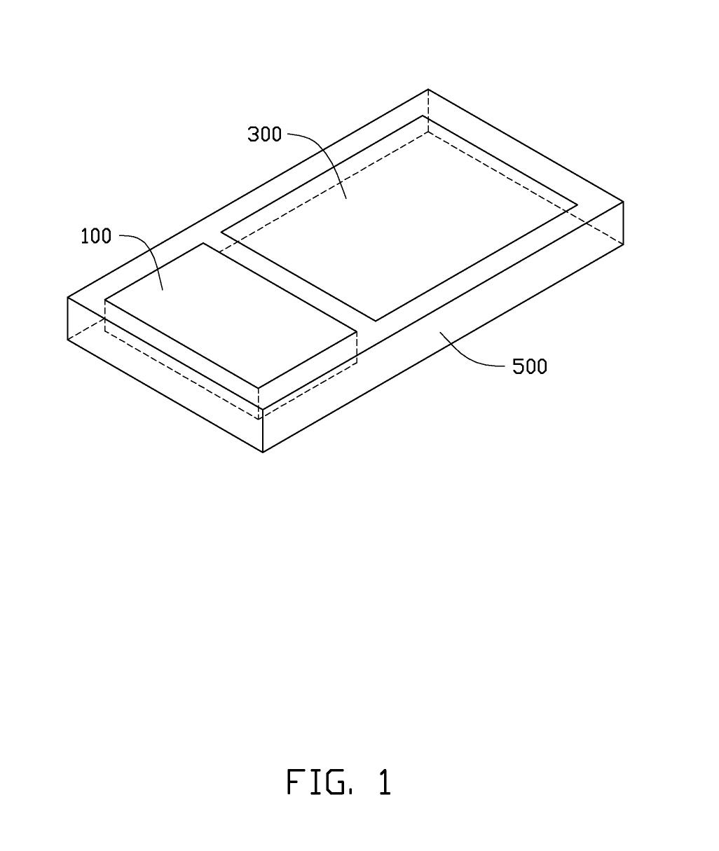

FIG. 1 shows a light guide module 100, which can be used in a portable electronic device 500, such as a cellular phone or any electronic device where a touch keypad is required. The portable electronic device 500 includes a display 300. The light guide module 100 and the display 300 are spaced apart in the portable electronic device 500. Users can input an instruction to control the portable electronic device 500 using a finger or a touch tool to touch the light guide module 100.

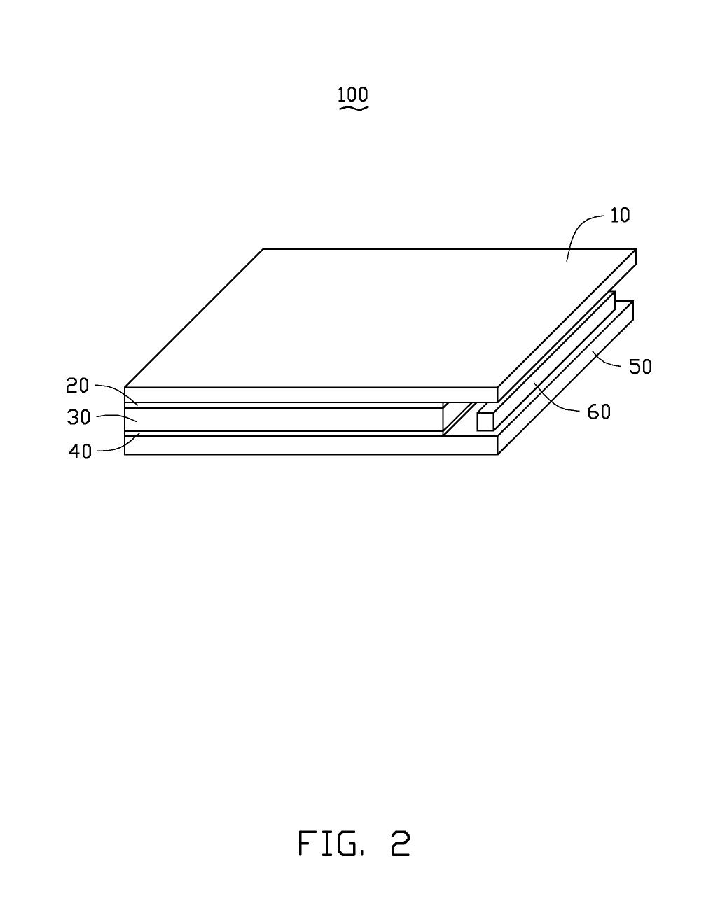

FIG. 2 shows a first exemplary embodiment of the light guide module 100. The light guide module 100 includes a touch plate 10, a transparent double sided tape 20, a light guide plate 30, a reflective double sided tape 40, an induction plate 50, and a light source 60. The touch plate 10, the transparent double sided tape 20, the light guide plate 30, the reflective double sided tape 40 and the induction plate 50 are positioned in that order. The light source 60 is located on the induction plate 50 and faces the touch plate 10. The light guide plate 30 transmits light emitted from the light source 60 to the touch plate 10.

The touch plate 10 is made of a transparent material such as plastic. The plastic material can be any of polycarbonate (PC) and polymethyl methacrylate (PMMA). The touch plate 10 includes a first surface 102 and a second surface 104. The first surface 102 is used by the user for touching. The second surface 104 has a plurality of key icons (not shown) and a plurality of shaded portions surrounding the key icons. The key icons have partially transmissive portions and can be illuminated when light from the light source 60 is transmitted to the touch plate 10.

The light guide plate 30 is positioned under the touch plate 10 and is made of a transparent material such as glass or plastic. The plastic material can be any of PC, polyethylene terephthalate (PET), PMMA. One surface of the light guide plate 30 includes a plurality of micro dots 32. The micro dots 32 are spaced from each other. The density and size of the micro dots 32 vary as the distance of the micro dots 32 relative to the light source 60 changes. In the exemplary embodiment, the micro dots 32 adjacent to the light source 60 have a smaller density and a smaller size. As the distance of the micro dots 32 relative to the light source 60 increases, the density and the size of the micro dots 32 increases. The arrangement of the micro dots 32 scatter and reflect more light toward the touch plate 10. The micro dots 32 may be concave or convex and may be formed by etching.

The induction plate 50 may be a printed circuit board (PCB), flexible printed circuit board (FPCB), or indium tin oxide (ITO) type PCB. The induction plate 50 has a plurality of detecting areas corresponding to the key icons on the touch plate 10. When user touches a position on the touch plate 10, the corresponding detecting area of the induction plate 50 can detect a touch position coordinate made by the user, and produce a corresponding command signal to the electronic device.

The transparent double sided tape 20 is used for adhering the touch plate 10 and the light guide plate 30. In this exemplary embodiment, the transparent double sided tape 20 is adhered to the second surface 104 of the touch plate 10 and another surface of the light guide plate 30 without the micro dots 32.

The reflective double sided tape 40 is adhered to the surface of the light guide plate 30 with the micro dots 32 and the induction plate 50. The color of the reflective double sided tape 40 is silver and can reflect the light emitting from the light source 60 toward the light guide plate 30, to achieve a planar light source having uniform brightness. The reflective double sided tape 40 functions mainly as a reflective element, to ensure that most of the light emitted from the light source 60 enter the light guide plate 30.

The light source 60 can be light emitting diodes (LED) and is mounted on one side of the induction plate 50. The light source 60 is located between the induction plate 50 and the touch plate 10 and is positioned at one side of the transparent double sided tape 20, the light guide plate 30 and the reflective double sided tape 40. The light source 60 is used for providing light to the light guide module 100.

In use, the emitted light of the light source 60 is guided by the reflective double sided tape 40 to the light guide plate 30, and then, the light is reflected by the reflective double sided tape 40 to penetrate through the light guide plate 30. The micro dots 32 scatter and reflect more light toward the transparent double sided tape 20 and the touch plate 10. Finally, the light passes through the transparent double sided tape 20 to illuminate the second surface 104 of the touch plate 19. Thus, the key icons are shown on the first surface 102 of the touch plate 10. The present light guide module 100 uses the transparent double sided tape 20 and the reflective double sided tape 40 to reduce the distance between the touch plate 10 and the induction plate 50. The touch keypad is more sensitive and more easily to be operated.

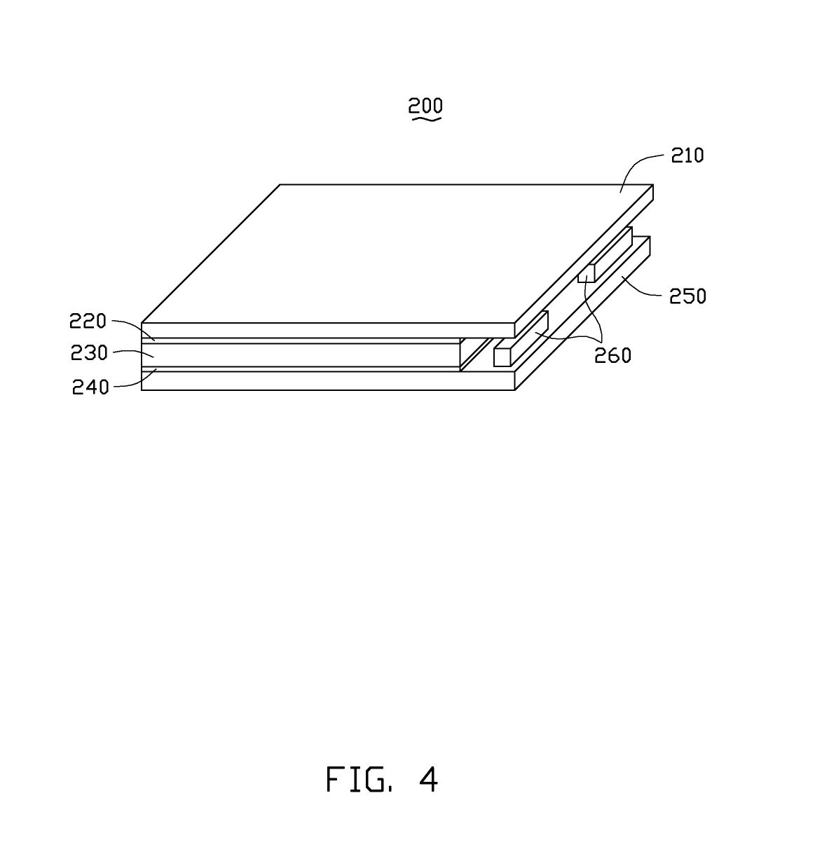

In a second exemplary embodiment, referring to FIG. 4, the light guide module 200 includes a touch plate 210, a transparent double sided tape 220, a light guide plate 230, a reflective double sided tape 240, an induction plate 250, and two light sources 260. The touch plate 210, the transparent double sided tape 220, the light guide plate 230, the reflective double sided tape 240, and the induction plate 25 are similar to the elements of the first exemplary embodiment, herein are not detailed. The difference of the second exemplary embodiment relative to the first exemplary embodiment is that the light guide module 200 includes the two light sources 260 adjacent to each other. The light sources 260 are used for providing light to the light guide module 200.

It is believed that the present embodiments and their advantages will be understood from the foregoing description, and it will be apparent that different changes may be made thereto without departing from the spirit and scope of the present disclosure or sacrificing all of its material advantages, the examples hereinbefore described merely being preferred or exemplary embodiments of the present disclosure.

1. A light guide module comprising:
a touch plate;
a light guide plate;
an induction plate;
a transparent double sided tape adhered between the touch plate and the light guide plate;
a reflective double sided tape adhered between the light guide plate and the induction plate; and
a light source located on the induction plate;
wherein the reflective double sided tape reflects light emitted by the light source to the light guide plate, the light guide plate directs the light to the touch plate through the transparent double sided tape.

2. The light guide module as claimed in claim 1, wherein the touch plate is made of a transparent material.

3. The light guide module as claimed in claim 1, wherein one surface of the light guide plate includes a plurality of micro dots, the micro dots are spaced from each other, the density and size of the micro dots vary with the distance of the micro dots from the light source.

4. The light guide module as claimed in claim 3, wherein the micro dots are concave or convex.

5. The light guide module as claimed in claim 1, wherein the color of the reflective double sided tape is silver.

6. A portable electronic device comprising:
a display; and
a light guide module spaced apart from the display, the light guide module comprising:
a light guide plate;
an induction plate;
a reflective double sided tape adhered between the light guide plate and the induction plate; and
a light source located on the induction plate;
wherein the reflective double sided tape reflects light emitted by the light source to the light guide plate.

7. The portable electronic device as claimed in claim 6, further comprising a touch plate, wherein the touch plate is adhered on the light guide plate.

8. The portable electronic device as claimed in claim 7, further comprising a transparent double sided tape, wherein the transparent double sided tape is adhered between the touch plate and the light guide plate.

9. The portable electronic device as claimed in claim 6, wherein the touch plate is made of a transparent material.

10. The portable electronic device as claimed in claim 6, wherein one surface of the light guide plate includes a plurality of micro dots, the micro dots are spaced from each other, the density and size of the micro dots vary with the distance of the micro dots from the light source.

11. The portable electronic device as claimed in claim 10, wherein the micro dots are concave or convex.

12. The portable electronic device as claimed in claim 6, wherein the color of the reflective double sided tape is silver.
